(19) United States
(12) Patent Application Publication
(10) Pub. No.: US 2021/0226280 A1
(43) Pub. Date: Jul. 22, 2021

(54) COOLING SYSTEM FOR ENERGY STORAGE DEVICES

(71) Applicant: TIAX LLC, Lexington, MA (US)

(72) Inventor: John Dieckmann, Lexington, MA (US)

(21) Appl. No.: 17/055,183

(22) PCT Filed: May 16, 2018
(86) PCT No.: PCT/US2018/032925

§ 371 Date: Nov. 13, 2020

(51) Int. Cl. H01M 10/6556; H01M 10/052; H01M 10/613; H01G 11/18

(52) U.S. Cl. CPC H01M 10/6556; H01G 11/18; H01M 10/613; H01M 10/052

(57) ABSTRACT

Provided is a thermal management device for an energy storage device with suitable architecture to accommodate any design of electrochemical ceil. A thermal management device may include a plurality of posts suitably shaped and sized to house a fluid feed tube and a fluid return tube in fluid communication with the fluid feed tube, a fluid supply manifold in fluid communication with the fluid feed tube, and a fluid return manifold in fluid communication with the fluid return tube.

This invention was made with U.S. government support under grant N00014-13-P-1146 awarded by the Office of Naval Research. The U.S. government has certain rights in the invention.

### FIELD

This disclosure relates generally to energy storage devices, and more particularly to a means for cooling energy storage devices, optionally in the form of an elongated shape, e.g., lithium-ion or lithium-metal batteries.

### BACKGROUND

Energy storage is becoming a key enabler for power systems operating with high levels of transient power requirements. Proper thermal management of high power systems, with minimal impact on weight and volume is key to enable applications with improved reliability and system energy density. Electrical energy storage devices—e.g., rechargeable batteries—all suffer some level of energy conversion loss as they are charged and discharged. Lithium-ion and other lithium-based rechargeable batteries lose electrical energy to IR voltage loss as current flows through the anode and cathode electrodes. The lost electrical energy is dissipated as heat. In energy storage systems intended to operate at high power levels, with full charge and discharge cycles on the order of minutes in length, active cooling is required to remove the dissipated heat and limit the temperature of the battery to the maximum temperature consistent with maintaining performance and long cycle life. In lower power energy storage systems, for example with charge and discharge cycles on the order of an hour or a few hours, thermal management to maintain temperature uniformity can extend cycle life significantly.

Cooling of energy storage devices can be accomplished in a variety of ways. One method is air cooling by flowing cold air over the cell surface. The disadvantages of this method are that significant flow rates of air are needed to ensure narrow temperature gradients within the pack, adding to the parasitic load of the battery pack.

Another method practiced is the use of liquid coolants, with many different approaches to contact liquid coolant with the cells. In one method of contact, cooling pipes contact each individual cell. However, the disadvantage with this method is that the cooling pipes add significant weight and volume to the battery pack.

Thus there remains a need for an improved cooling architecture.

### SUMMARY

A scalable cooling architecture for arrays of cylindrically-shaped energy storage devices. The approach places an array of coolant-carrying posts in the spaces between individual cells in an array of cells. This architecture, with minimal impact on weight and volume, will not only enable cells to be discharged at high rates, but in the case of lithium-ion batteries, also render the system safe in the event of thermal runaway in any of the cells. This architecture enables efficient contact between the coolant and the cells, thereby minimizing the flow rate of coolant needed.

### BRIEF DESCRIPTION OF THE DRAWINGS

Referring now to the figures, which are exemplary embodiments, and wherein the like elements are numbered alike:

FIG. 1 is an exemplary cooling post array assembly for a 10×10 cell array according to an aspect of this disclosure;

FIG. 2A shows detail of cooling posts and cooling fluid supply and return manifold from a cross sectional view according to an aspect of this disclosure;

FIG. 2B shows detail of cooling posts and cooling fluid supply and return manifold from a top view according to an aspect of this disclosure;

FIG. 3 is an isometric view of cooling post assembly for a 10×10 array of cells according to an aspect of this disclosure; and

FIG. 4 is an exploded view of cooling post assembly for 10×10 cell array according to an aspect of this disclosure wherein electrical feed-throughs in the bottom plate are not shown.

### DETAILED DESCRIPTION

Provided herein is a thermal management device that may be used to cool or otherwise regulate the temperature of any structure that is suitable sized and shaped so as to be complementary to the architecture of the provided device. The architecture of the thermal management device as provided herein overcomes the shortcomings of the previous approaches by providing for an efficient contact of coolant with the cells. Specifically, our approach minimizes the weight and volume of the coolant sub-system, reduces the parasitic burden on the system, and ensures uniform thermal regulation of the cells.

Disclosed is a scalable cooling architecture that may be used for arrays of cylindrically-shaped energy storage devices. The approach places an array of fluid-cooled, e.g., water-cooled, posts in the spaces between individual cells in an array of cells. This architecture, with minimal impact on weight and volume, enables cells to be discharged at high rates, and in the case of lithium-ion batteries, also renders the system safe in the event of thermal runaway in any of the cells.

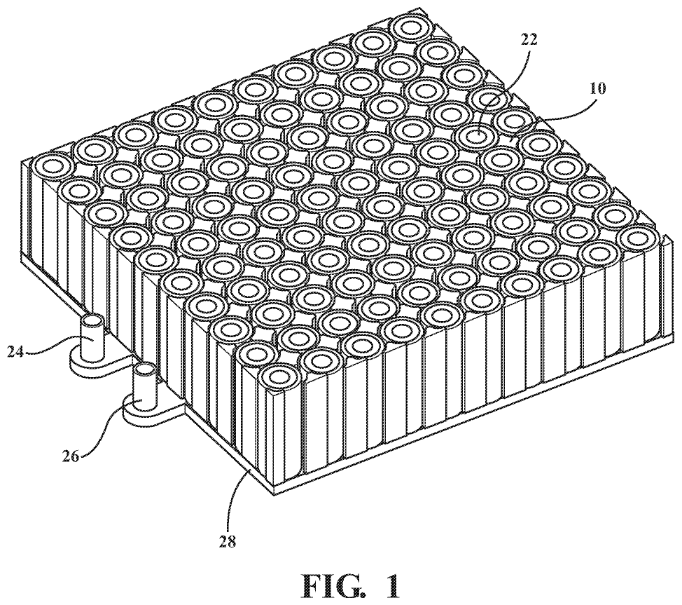

The disclosed architecture provides one or more fluid-cooled posts 10 in the space between individual cells, as shown in FIG. 1 for a illustrative, 10×10 array of cells. The fluid-cooled posts 10 may be formed of any material that will conduct thermal energy, optionally aluminum. While a close-square packed array of cells 22 is illustrated, cooling posts 10 may be deployed in any packing arrangement of cells that is desired, for example, hexagonally close packed, or arrays that are not close packed.

Rack-mounted arrays of batteries or other cylindrical energy storage devices do not interface well with cold plates and other typical cooling approaches. The cooling system architecture disclosed herein provides a volumetrically efficient, thermally effective connection to each cell in any array of cells that can be connected to a cooling source, for example, a fresh fluid cooling loop that would be accessed at the back plane of the cabinet holding the battery racks. The proposed system provides cooling performance without requiring chilled fluid (although such may be used), but rather optionally uses a fresh fluid cooling loop that may be cooled via heat exchange with a fluid, optionally sea fluid, (if necessary). Note that in warmer locations, e.g., the Red Sea, the resulting fresh cooling fluid supply temperature may be as high as 40° C.

The lifetime and performance of lithium-ion batteries is particularly sensitive to temperature, which should generally be limited to ˜60° C. While the cooling architecture is to apply generally to different types of energy storage devices, high-power rechargeable lithium-ion batteries represent a most-demanding, worst case, given the sensitivity of performance and cycle life to temperature. While the primary application for this cooling technology is lithium-ion battery cooling, this basic cooling architecture can be readily applied to capacitors and other rechargeable battery chemistries.

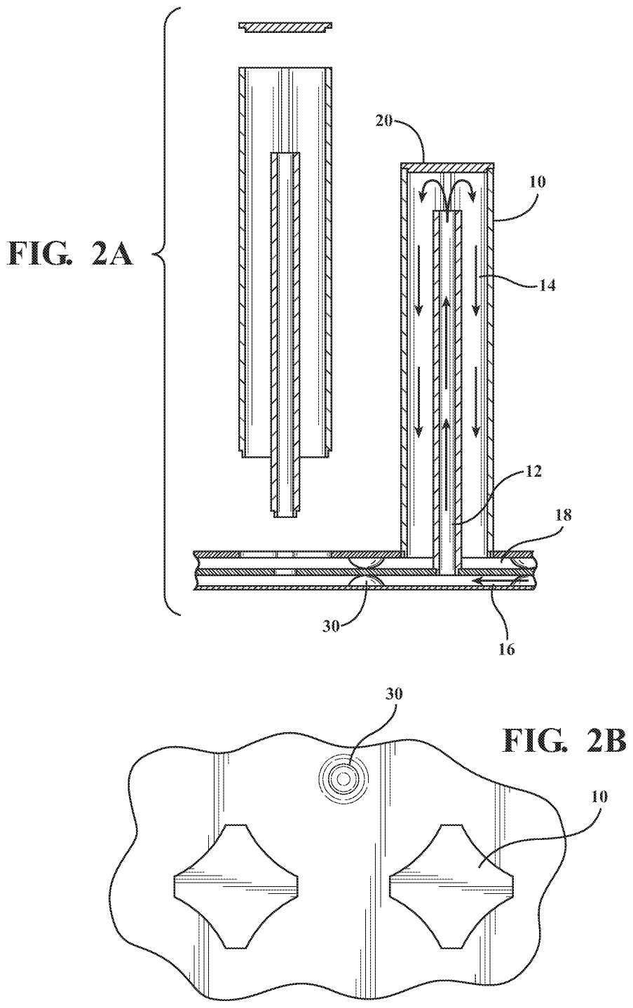

The fluid-cooled posts 10 depicted in FIG. 1 and from a top view in FIG. 2B are optionally contoured to conform to the cylindrical can of the battery. Allowing for reasonable tolerances, heat is conducted from the surface of the cylindrical can of the battery to the cooling post across a narrow air gap (optionally on the order of 0.25 mm) and the thickness of an optional dielectric layer (preferably with high thermal conductivity) that ensures that the cells are electrically isolated from the cooling post. As illustrated in FIG. 2A, cooling fluid supply 16 and return 18 manifolds are contained in the base plate 28. Cooling fluid supply 24 and return 26 connections can be located on any side of the base plate 28, for example on the side facing the back plane of the rack cabinet, as shown in FIG. 1. The complete assembly serves as a battery rack—space is available between the cooling posts to provide series connections between cells and battery (electrical, charge) management. Preliminary thermal modeling shows that this cooling geometry is highly scalable, capable of cooling cells sized anywhere from small 18650 cells to larger format cells in excess of 2 inches in diameter. In addition to scaling with cell size, arrays of any number of cells can be accommodated.

FIGS. 2A and B illustrate the details of an exemplary individual cooling post 10 configuration and its connection to the fluid supply 16 and return 18 manifold. The cooling post itself may include a hollow post 10 and a cap 20 (each of which may be fabricated from the same thermally conductive material, optionally aluminum). A fluid feed tube 12 connected to the cooling fluid supply manifold 16 is positioned centrally the post, optionally in the center of the post. Cooling fluid flows up the fluid feed tube 12 to the top of the post 10, then down the annular space between the cooling post and the fluid supply tube through a fluid return tube or space 14. The manifolds 16, 18, which optionally also serve as a base plate, may be formed from three thin sheets of a metal such as aluminum, with holes matching the cooling posts punched into the top sheet and with holes matching the tubes punched into the middle sheet. The top and bottom sheets may be dimpled 30 to provide correct spacing and multiple spots to join the three sheets together. The cooling posts may be extruded and cut to length, the caps may be the pieces stamped out of the top manifold sheet, and the tubes may be cut to length from a coil of tubing. It is to be appreciated that the exemplary fluid flow direction is optional and may be reversed in some aspects.

Alternatively, the cooling post could be formed from a solid extrusion, with the center hole drilled to the appropriate depth. The entire assembly is vacuum furnace brazed together (or with another suitable brazing process), with suitable fixturing.

A further alternative is to fabricate this geometry from copper and/or brass parts and solder them together with a suitable solder alloy and flux in a suitable soldering oven. While aluminum, copper, and brass are mentioned, any suitable metal or other material may be used and other forming, fabrication and joining methods may be used, the details of which can be determined by one skilled in the art without undue experimentation. Very little volume is added to the battery array, because the cooling posts occupy empty space between the cylindrical cells and the fluid manifold layers of the base plate serve as the base plate of a robust battery rack. The thickness of the base plate is approximately 10% of the length of the cells.

As exemplified in FIG. 1, the cooling posts are optionally roughly the length of one cell. The disclosed architecture is not limited to a single cell length cooling post, rather the cooling posts can be the length of two or more cells, and that number of cells would be stacked up in the space between each set of cooling posts. The practical limitation will be the amount of cooling fluid flow required to adequately cool multiple cells.

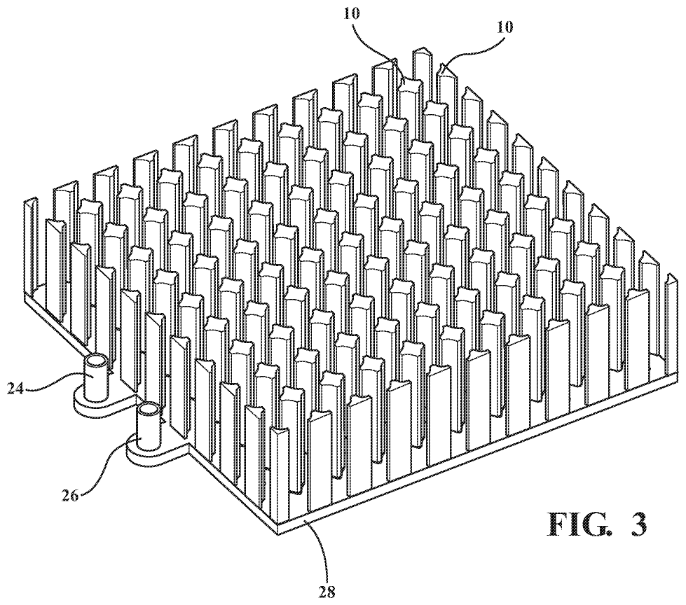

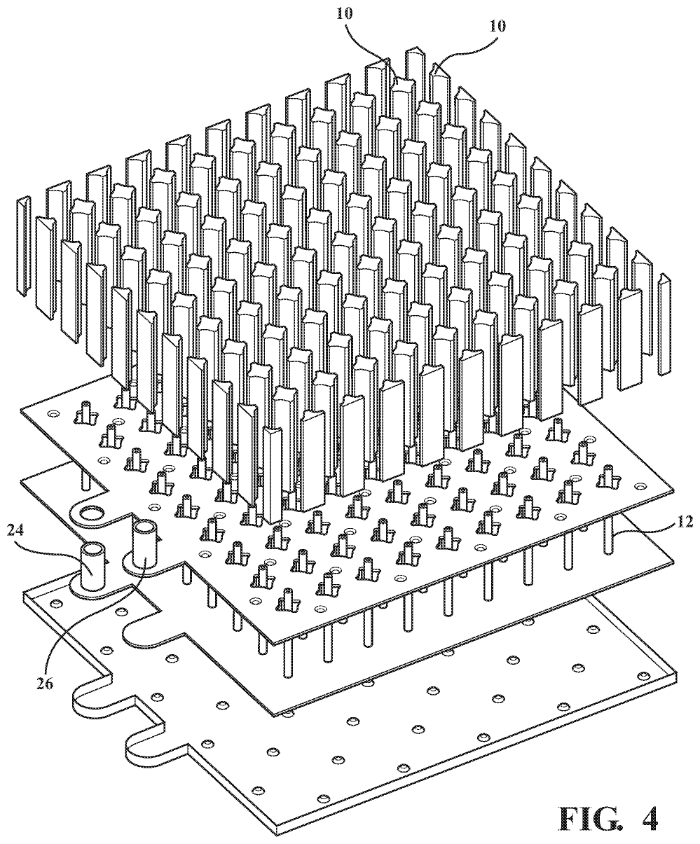

The design presented in FIGS. 2A and B uses the fluid cooling loop fluid flow directly, so additional heat exchangers and pumps are not necessary. The cooling fluid flow rate that is used for each cell can be very low, optionally 0.02 gallons per minute for a high-power 26650 cell with a fluid temperature rise of only 2° C. For the exemplary 10×10 array depicted in FIGS. 1, 3, and 4 the total cooling fluid flow would only be two gallons per minute.

The manifold construction described above uses dimples in the sheet metal layers as a low cost method to provide both spacers and points brazed together to support internal pressure. Higher design internal pressures can be readily accommodated by increasing the number of dimples (decreasing the spacing between dimples). Alternatively, instead of dimples a variety of other spacer arrangements may be used, including, for example, machined stand-offs or small, individual spacers.

The proposed geometry has the flexibility to also be implemented with cooling provided by a two-phase cooling loop or as a heat pipe. In a two phase loop, the circulating refrigerant liquid and vapor may follow the same flow pattern as used for fluid cooling. For a heat pipe, heat collected by the cooling posts would cause the heat pipe working fluid to vaporize, and then the vapor would flow to a fluid-cooled heat sink at the back of the array. The supply and return manifolds and fluid inlet tubes to each cooling post would be replaced with single manifold and wicking surfaces to return liquid working fluid to the surface of the cooling post.

It is noteworthy that the proposed cooling arrangement effectively surrounds each cell with a heat sink. If an individual cell undergoes a thermal runaway, thermal modeling experience suggests that the cooling posts adjacent to the cell will rapidly absorb the heat released by the runaway. At the same time, cooling posts surrounding the other cells will shield them from the extreme temperature of the runaway cell, preventing cascading.

Additional geometric features may be employed to assist with centering the cooling feed tube inside the cooling post, to provide space for electrical interconnects between cells, and to provide increased surface area for more robust braze or solder joints.

The air gap between the cells and the cooling post may be used to accommodate variations in the diameter of the cells. Both thermal modeling and laboratory test results have shown that thermal conduction across this air gap is the most significant thermal resistance in this cooling system. Several methods may be employed to improve the thermal conduction across this gap, for example, insertion of metal or plastic shims between the cell and the cooling posts, filling the gap with any of many thermal greases and the like, and insertion of thermal contact pads into the gap.

Although the exemplary aspects as illustrated herein use water as the coolant, the architecture disclosed here can be used with any type of fluid. The fluid may include any suitable fluid (liquid or gas), such as water or an organic solvent. The organic solvent may comprise an alcohol, a ketone, an ester, or a combination thereof. The alcohol may be a polyol, e.g., a glycol. Examples of the fluid include: ethylene glycol, propylene glycol, solutions of water with ethylene or propylene glycol or other antifreeze compounds, and fluorofluids. Water is specifically mentioned. The fluid may further include one or more additives such as a corrosion inhibitor.

Although the examples listed here use 26650 cells, the architecture disclosed here can be used with a wide range of cylindrical cell designs with a wide range of aspect ratios.

The disclosed aspects may be embodied in many different forms, and this disclosure should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

Various modifications of the present invention, in addition to those shown and described herein, will be apparent to those skilled in the art of the above description. Such modifications are also intended to fall within the scope of the appended claims.

It is appreciated that all materials are obtainable by sources known in the art unless otherwise specified.

The foregoing description is illustrative of particular aspects of the invention, but is not meant to be a limitation upon the practice thereof. The following claims, including all equivalents thereof, are intended to define the scope of the invention.

1. A thermal management device for an energy storage device comprising:
a post comprising a fluid feed tube and a fluid return tube in fluid communication with the fluid feed tube, the fluid feed tube and fluid return tube within the post;
a fluid supply manifold in fluid communication with the fluid feed tube; and
a fluid return manifold in fluid communication with the fluid return tube.

2. The thermal management device of claim 1, wherein the post is disposed on at least one of the fluid supply manifold and the fluid return manifold.

3. The thermal management device of claim 1, wherein an outer surface of the post has a shape configured to receive adjacent cells of the energy storage device.

4. The thermal management device of claim 3, wherein the outer surface of the post comprises a curvilinear side surface.

5. (canceled)

6. The thermal management device of claim 1, wherein the post further comprises a cap.

7. The thermal management device of claim 1, wherein the fluid feed tube is disposed in the fluid return tube.

8. The thermal management device of claim 1, wherein the energy storage device is a battery, a capacitor, or a combination thereof.

9. (canceled)

10. (canceled)

11. The thermal management device of claim 8, wherein the energy storage device comprises a lithium-metal battery.

12. The thermal management device of claim 1, wherein the energy storage device is a capacitor.

13. The thermal management device of claim 1, wherein the fluid return tube is a hole in the post.

14. A method of thermal management of an energy storage device, the method comprising:
providing the thermal management device of claim 1, said thermal management device in thermal communication with one or more cells of an energy storage device; and
urging a fluid from the fluid supply manifold, through the fluid feed tube, through the fluid return tube, and to the fluid return manifold to thermally manage the energy storage device.

15. The method of claim 14, wherein the post is disposed on at least one of the fluid supply manifold and the fluid return manifold.

16. The method of claim 14, wherein an outer surface of the post has a shape configured to receive adjacent cells of the energy storage device.

17. The method of claim 16, wherein the outer surface of the post comprises a curvilinear side surface.

18. (canceled)

19. The method of claim 14, wherein the post further comprises a cap.

20. The method of claim 14, wherein the fluid feed tube is disposed in the fluid return tube.

21. The method of claim 14, wherein the energy storage device is a battery, a capacitor, or a combination thereof.

22. (canceled)

23. (canceled)

24. The method of claim 21, wherein the energy storage device comprises a lithium-metal battery.

25. The method of claim 14, wherein the energy storage device is a capacitor.

26. The method of claim 14, wherein the fluid return tube is a hole in the post.
